(19) United States
(12) Patent Application Publication
(10) Pub. No.: US 2007/0201321 A1
(43) Pub. Date: Aug. 30, 2007

(54) Information Processing Device For Identifying The Type Of Recording Medium And Method For Forming Area On Recording Medium Executed In Information Processing Device

(76) Inventor: Shinji Sasaki, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/597,224

(22) PCT Filed: Jan. 18, 2005
(86) PCT No.: PCT/JP05/00523

§ 371 Date: Jul. 17, 2006

(30) Foreign Application Priority Data
Jan. 19, 2004 (JP) 2004-010092

(51) Int. Cl. G11B 7/00

(52) U.S. Cl. 369/44.13

(57) ABSTRACT

Different formats, whose defect management methods differ based on the presence or absence of a cartridge, are adopted for information storage media having the same physical characteristics. An information processing apparatus is capable of mounting a storage medium having a data recording area. The data recording area includes a user area to which logical addresses are allocated in accordance with recording units. The information processing apparatus includes: a determination section for, based on physical characteristics of the mounted storage medium, determining which one of a first storage medium accommodated in a cartridge and a second storage medium not accommodated in a cartridge has been mounted; a processor for, based on a result of determination, giving an instruction that, when the second storage medium has been mounted, the data recording area be formed as the user area and a spare area, and giving an instruction that, when the first storage medium has been mounted, all area of the data recording area be formed as the user area; and a recording section for, based on the instruction, forming the user area and/or the spare area in the data recording area of the mount storage medium. The spare area is to be used as a substitute if a defect exists in a recording unit of the user area.

### TECHNICAL FIELD

The present invention relates to a rewritable disk having a sector structure. Furthermore, the present invention relates to an apparatus capable of performing a data write and/or read for such a disk and a method thereof, and more specifically to an apparatus and method for performing a data write for a rewritable optical disk.

### BACKGROUND ART

Optical disks are known as typical examples of disks having a sector structure. In recent years, optical disks are increasing in density and capacity, which makes it especially important to ensure reliability. In order to ensure reliability, some disks are accommodated within cartridges so that users cannot directly touch the disks. However, use of a cartridge results in increased cost. Therefore, from the standpoint of marketing inexpensive disks, disks which do not utilize cartridges are also in use.

The DVD-RAM standard is known as a disk standard which permits a disk which is accommodated in a cartridge (hereinafter a “cartridge disk”) to be used in the same manner as a disk which is not accommodated in a cartridge (hereinafter a “bear disk”). Within the DVD-RAM standard, ECMA (European Computer Manufacturer Association) defines ECMA-330: 120 mm (4.7 Gbytes per side) and 80 mm (1.46 Gbytes per side) DVD Rewritable Disks (DVD-RAMs) as the disks, and defines Standard ECMA-331: Cases for 120 mm and 80 mm DVD-RAM Disks as the cartridge cases.

As described in e.g. Patent Document 1, in a DVD-RAM, data which cannot be written to the usual recording area because of soil or scratches is written to a spare area which is previously provided outside the recording area, thus to improve the disk reliability.

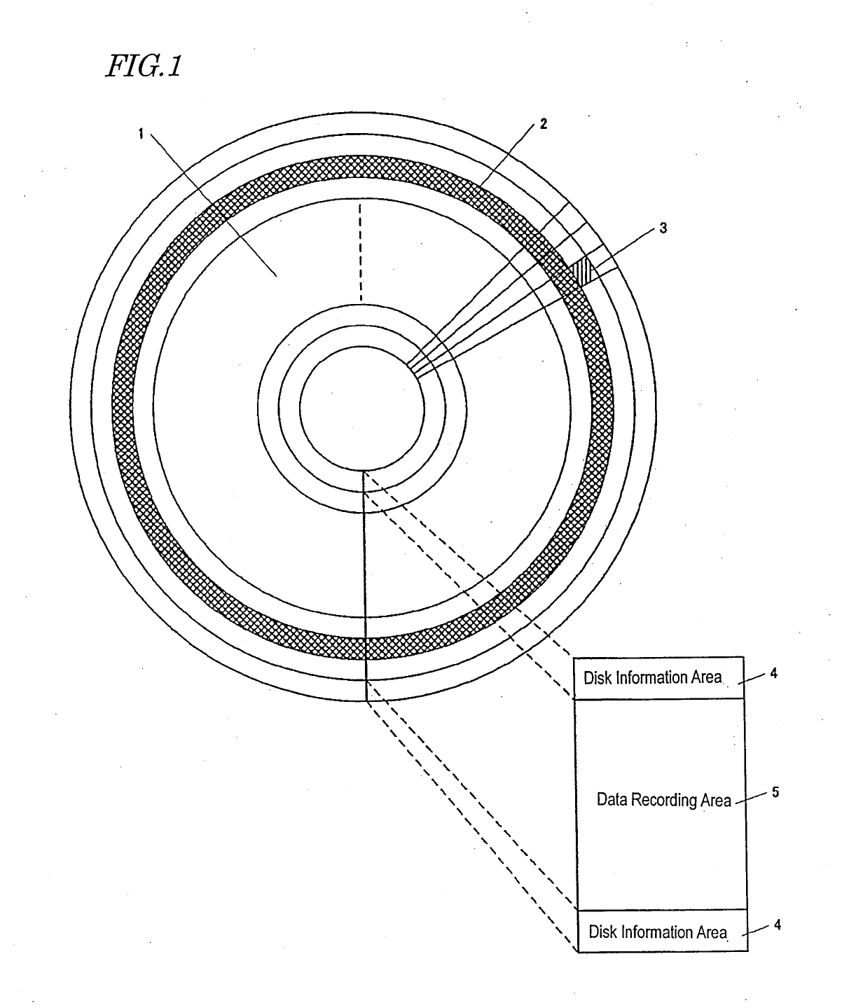

FIG. 1 shows the structure of a commonly-used optical disk. On a disk-shaped optical disk 1, tracks 2 are formed in concentric circles, and finely-divided sectors 3 are formed in each track. In every one of these sectors, an absolute address, called a physical sector number PSN (Physical Sector Number), is assigned.

The disk is composed of the following areas: disk information areas 4 and a data recording area 5. The disk information areas 4 store parameters and the like which are necessary for accessing the disk, and are positioned at the innermost periphery side and the outermost periphery side of the optical disk 1. The data recording area 5 store data, which is subject to reading.

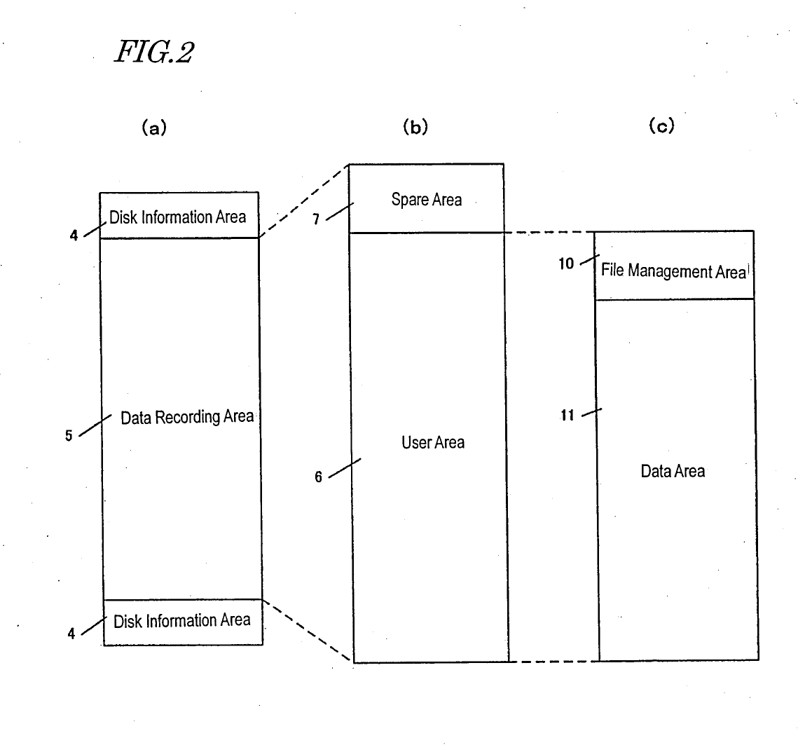

FIGS. 2(a) to (c) show a logical structure of the optical disk 1. FIG. 2(a) shows the area structure of the optical disk 1, which is as shown in FIG. 1.

FIG. 2(b) shows location of a user area 6 and a spare area 7, which are defined as parts of the data recording area 5. The user area 6 is an area which is provided for allowing the user to store data therein. Usually, the user writes data to the user area 6 by using an information processing apparatus.

Logical sector numbers LSN are given to the user area 6. An information processing apparatus designates a sector based on a logical sector number LSN, and performs a data write to that sector and a data read from that sector. The spare area 7 is an area in which, when any sector (defective sector) exists in the user area 6 where data could not be written due to scratches and soil, etc., the data which would have been written to that sector is to be recorded instead. Note that, although FIG. 2(b) illustrates the spare area 7 to be located above the user area 6 (e.g., the innermost periphery side of the optical disk 1), it may be located below the user area 6 (the outermost periphery side of the optical disk 1).

FIG. 2(c) shows an example of how the user area 6 may be utilized. In this case, the user area 6 can be divided into a file management area 10 and a data area 11. The file management area 10 stores location information which indicates where files and directories are located in the data area 11, position information of vacant areas in the data area 11, and the like. On the other hand, the data area 11 stores data such as directory information and the content of files.

FIGS. 2(a) and (b) above are to be defined as a physical format of the optical disk 1, whereas FIG. 2(c) is to be defined as a logical format of the optical disk 1. The location of the areas under the logical format can be freely determined by an information processing apparatus (or more specifically, by an application which is executed on an information processing apparatus and which corresponds to a file system of the optical disk 1). It may be arbitrary as to up to which sector position is the file management area 10 and from which sector position the data area 11 begins.

The optical disk 1 ensures reliability by using a defect list. A “defect list” is a list in which, when an error occurs during a data write or read, a pair consisting of a defective sector and a substitute sector is defined (registered) as one entry.

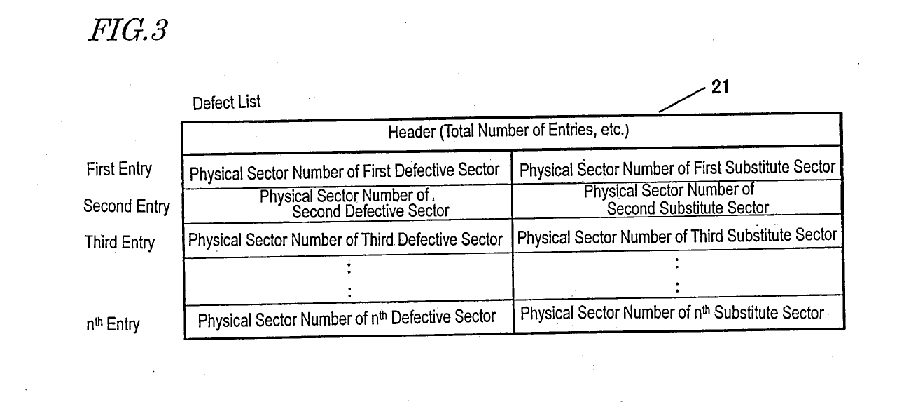

FIG. 3 shows a commonly-used data structure of the defect list 21. The defect list is stored in the disk information area 4 shown in FIG. 2(a). The defect list 21 is composed of a header and a plurality of entries. The header stores an identifier identifying itself to be a defect list, a total number of entries of defective sectors that are registered, and the like. Each entry stores a physical sector number indicating the position of a defective sector and a physical sector number of a substitute sector in which data is to be recorded in the place of the defective sector.

Next, a procedure of processes by an information processing apparatus (not shown) for writing data to and reading data from the aforementioned optical disk 1 will be described. The information processing apparatus may be an optical disk drive itself, or an apparatus in which an optical disk drive is incorporated.

Firstly, a procedure (1) and (2) of initialization processes (formatting processes) for the optical disk 1 will be described.

(1) First, based on tracks and sectors, the information processing apparatus allocates the disk information area 4 and the data recording area 5 as shown in FIG. 2(a). Thereafter, within the data recording area 5 of the optical disk 1, the information processing apparatus allocates the user area 6 and the spare area 7 as shown in FIG. 2(b). These processes are called a physical formatting process. Through the physical formatting process, the user area 6 is secured, to which logical sector numbers LSN are given. This makes it possible a data write from the information processing apparatus.

(2) Next, to the user area 6, the information processing apparatus allocates areas for writing the file management area 10 and the data area 11 as shown in FIG. 2(c). This is called a logical formatting process. The logical formatting process is a process of writing file management information, which differs from file system to file system (e.g., FAT or UDF), to the file management area 10. This makes it possible to access the directories and files on each file system.

Next, a procedure (3) to (5) of file recording processes for the optical disk 1 will be described.

(3) By utilizing the position information (logical sector numbers LSN) of vacant areas in the file management area 10, the information processing apparatus determines which position in the data area 11 a file is to be written to.

(4) Based on the determined position information, i.e., a logical sector number LSN, the information processing apparatus writes data composing the file to the data area 11.

(5) If any defective sector exists during the write, the data which would have been recorded to that defective sector is recorded in the spare area 7. At this time, a pair consisting of the address of the defective sector and the address of the substituted spare area is registered to the defect list.

Next, a procedure (6) to (8) of file reading processes will be described.

(6) The information processing apparatus reads the location information which is stored in the file management area 10, and based on this information, determines a position (logical sector number LSN) to be read.

(7) Based on the determined logical sector number LSN, the information processing apparatus reads data composing the file from the data area 11.

(8) When reaching a sector position which was recognized as a defective sector during data write, data is read from the address of a substitute sector which is registered in the defect list.

Through the procedure from (1) to (8) above, the information processing apparatus realizes data write and read processes. It will be understood that the conventional method improves reliability by redirecting any data that cannot be recorded in the user area to the spare area.

Patent Document 1: Japanese Laid-Open Patent Publication No. 2000-195

### DISCLOSURE OF INVENTION

### Problems to be Solved by the Invention

However, under the presence of a defective sector, if a redirection to the spare area which is at the disk innermost periphery side or the outermost periphery side is made, a problem arises in that a longer physical distance must be moved, thus resulting in a longer time being required for the seek operation of the optical head. This may cause disruptions in processing, especially during a write or read of a file which requires real-time processing, e.g., video data.

Moreover, since a common defect management method is adopted for both bear disks and cartridge disks, the recordable data amount in the entire disk is reduced by an amount corresponding to the spare area. This means that, although a cartridge disk suffers a cost for ensuring reliability in the form of enclosure within the cartridge, it only allows write video data to be written only for the same amount of time as on an inexpensive bear disk. This will prevent cartridge disks from gaining prevalence because of being relatively expensive disks.

An object of the present invention is to adopt different formats, whose defect management methods differ based on a predetermined criterion, for information storage media having the same physical characteristics.

### MEANS FOR SOLVING THE PROBLEMS

An information processing apparatus according to the present invention is capable of mounting a storage medium having a data recording area. The data recording area includes a user area to which logical addresses are allocated in accordance with recording units. The information processing apparatus includes: a determination section for, based on physical characteristics of the mounted storage medium, determining which one of a first storage medium accommodated in a cartridge and a second storage medium not accommodated in a cartridge has been mounted; a processor for, based on a result of determination, giving an instruction that, when the second storage medium has been mounted, the data recording area be formed as the user area and a spare area to be used as a substitute if a defect exists in a recording unit of the user area, and giving an instruction that, when the first storage medium has been mounted, all area of the data recording area be formed as the user area; and a recording section for, based on the instruction, forming the user area and/or the spare area in the data recording area of the mount storage medium.

The determination section determines mounting of one of the first storage medium and the second storage medium based on physical characteristics of the storage medium which differ based on presence or absence of a cartridge.

The information processing apparatus further includes a detection section for outputting different signals based on a change in physical state that is based on a physical shape of the cartridge. The determination section may determine which one of the first storage medium and the second storage medium has been mounted based on the signal which is output from the detection section.

The first storage medium and the second storage medium have substantially the same recording capacity. The information processing apparatus may be capable of mounting a third storage medium having a recording capacity different from recording capacities of the first storage medium and the second storage medium; and the determination section may further determine mounting of the third storage medium based on physical characteristics of the storage medium which differ depending on recording capacity.

The determination section further determines mounting of the third storage medium based on recording density.

The first storage medium and the second storage medium have substantially the same number of recording layers, and the third storage medium has a different number of recording layers from the number of recording layers of the first storage medium and the second storage medium. The determination section may further determine mounting of the third storage medium based on optical characteristics which differ depending on the number of recording layers.

The third storage medium may have a different physical shape from those of the first storage medium and the second storage medium; and the determination section may further determine mounting of the third storage medium based on the physical shape.

The information processing apparatus may further include a first detection section and a second detection section for outputting different signals based on a change in physical state that is based on a physical shape of the cartridge; the first detection section and the second detection section may be located so as to output different signals when the first storage medium is mounted, based on the physical shape of the cartridge, and output the same signal when the third storage medium is mounted; and the determination section may determine mounting of the third storage medium based on the signals which are output from the first detection section and the second detection section.

The information processing apparatus further includes a driving section for driving a mounted storage medium. In accordance with a mass of the mounted storage medium, the driving section may adjust a physical parameter which is necessary for driving the storage medium under a predetermined condition; and the determination section may determine mounting of the third storage medium based on information concerning the physical parameter adjusted by the driving section.

The first storage medium and the second storage medium each includes an information area storing information identifying the type of storage medium, the information area being different from the data recording area. The determination section may determine which one of the first storage medium and the second storage medium has been mounted by reading the information from the information area of the mounted storage medium.

An area formation method according to the present invention is to be executed in an information processing apparatus capable of mounting a storage medium having a data recording area. The data recording area includes a user area to which logical addresses are allocated in accordance with recording units. The area formation method includes the steps of: determining which one of a first storage medium accommodated in a cartridge and a second storage medium not accommodated in a cartridge has been mounted based on physical characteristics of the mounted storage medium; based on a result of determination, giving an instruction that, when the second storage medium has been mounted, the data recording area be formed as the user area and a spare area to be used as a substitute if a defect exists in a recording unit of the user area, and giving an instruction that, when the first storage medium has been mounted, all area of the data recording area be formed as the user area; and a step of, based on the instruction, forming the user area and/or the spare area in the data recording area of the mount storage medium.

### EFFECTS OF THE INVENTION

According to the present invention, even with respect to disk media of the same physical characteristics, different disk initialization processes are performed depending on whether they are accommodated in a cartridge or not, thus making it possible to adopt defect management methods which are optimum for the disk configurations, and enhancing reliability.

In particular, according to the present invention, no spare area is provided for a cartridge disk, so that user data can be written to the entire data recording area. When a cartridge disk is used for video recording, it becomes possible to record longer hours of video images than is possible with a bear disk, thus improving the user's convenience. For example, as compared to a bear disk which has a spare area capacity of 5 GB within a total recording capacity of 50 GB, a cartridge disk according to the present invention allows at least two more hours of video to be recorded, in the case of MPEG2 video data (5 Mbps). Since this time increases as the disk capacity increases, the effect thereof will become more outstanding with future increases in disk capacity. As a result, although the user will need to pay the cost of enclosure within the cartridge for a cartridge disk, it may become possible to make the cost per unit capacity equal to or less than that of a bear disk.

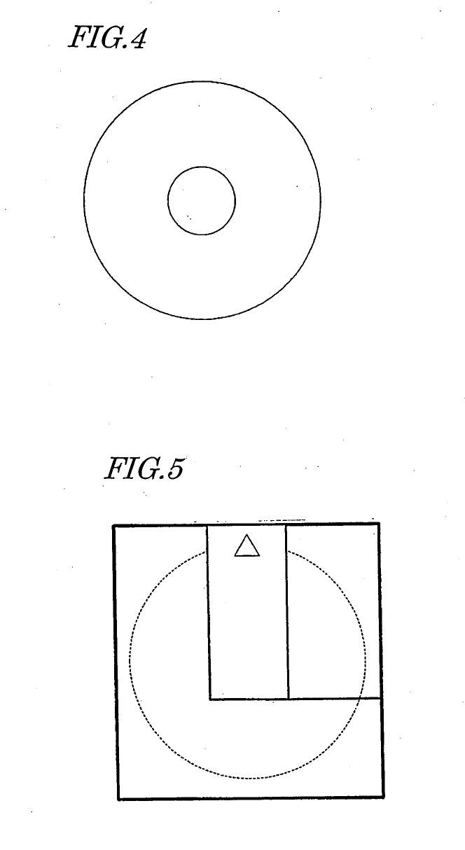

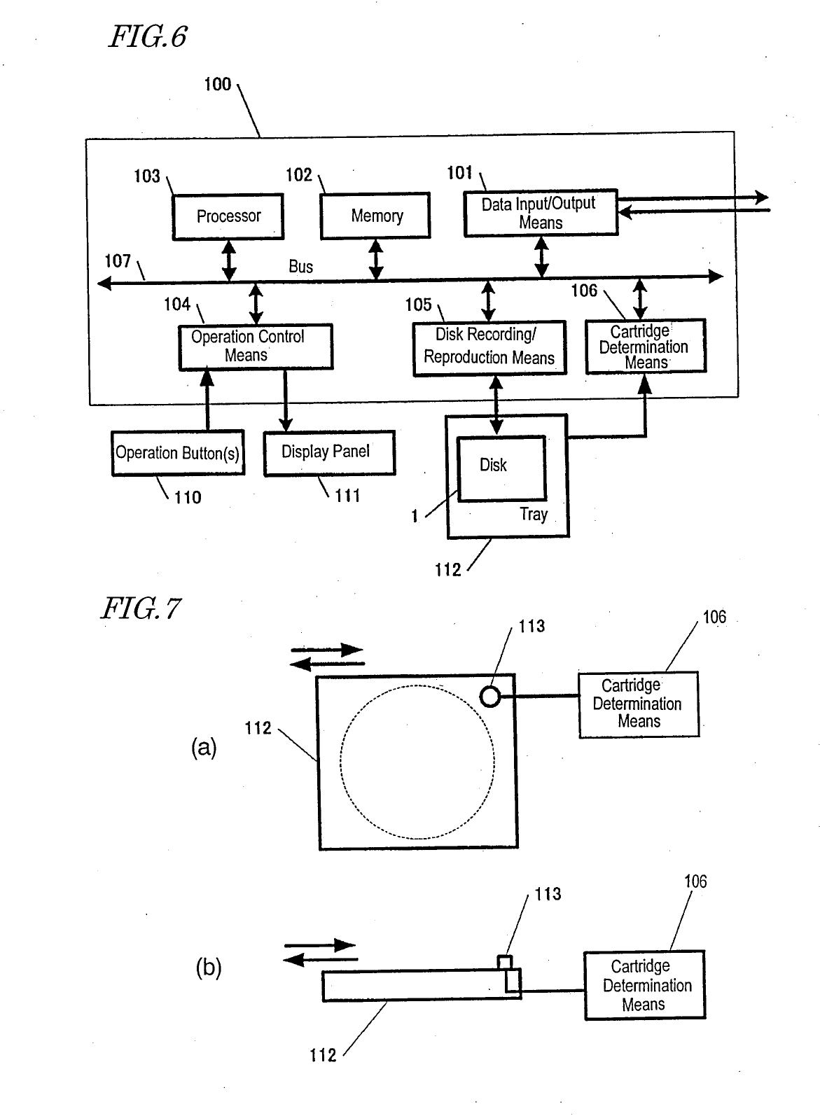

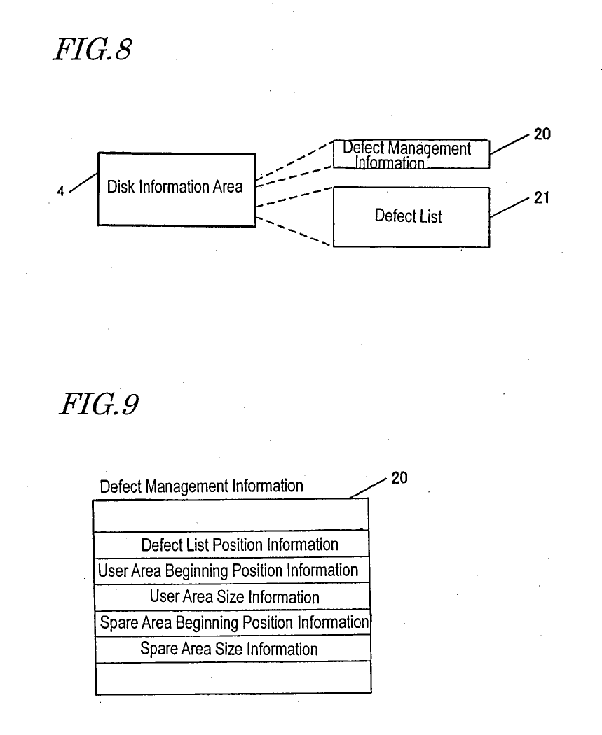

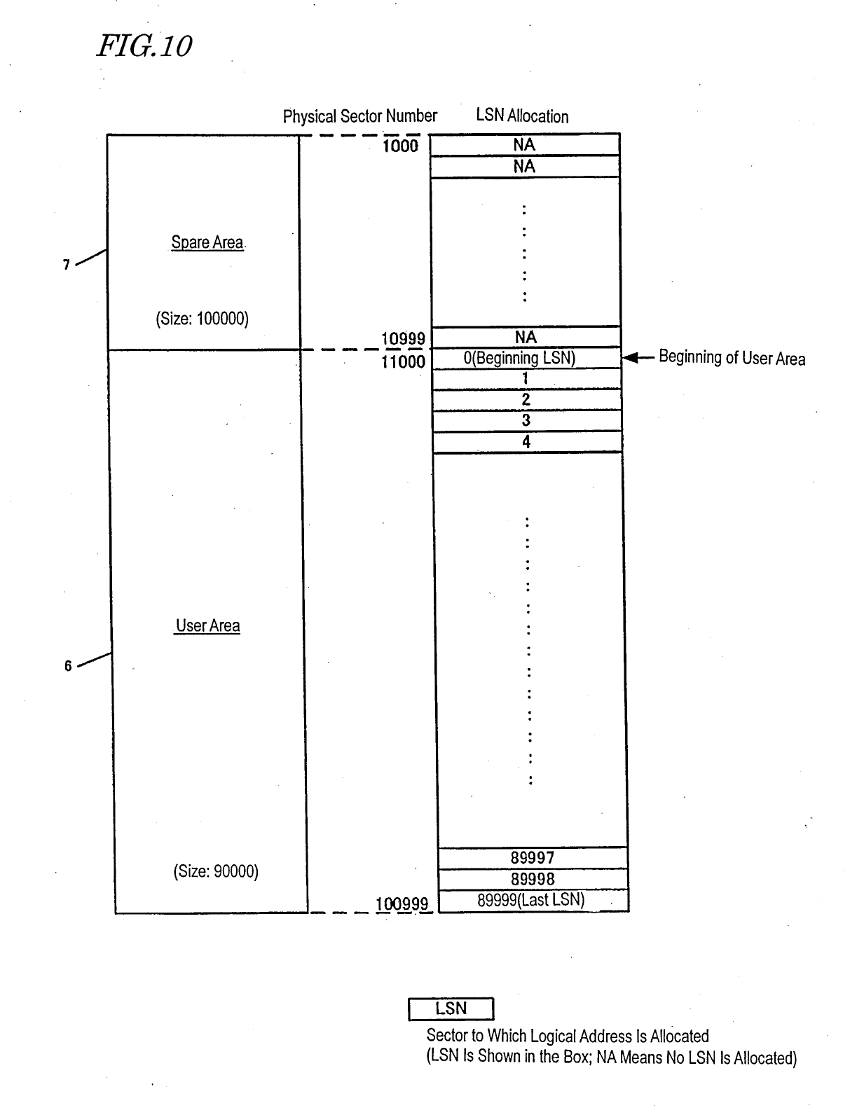

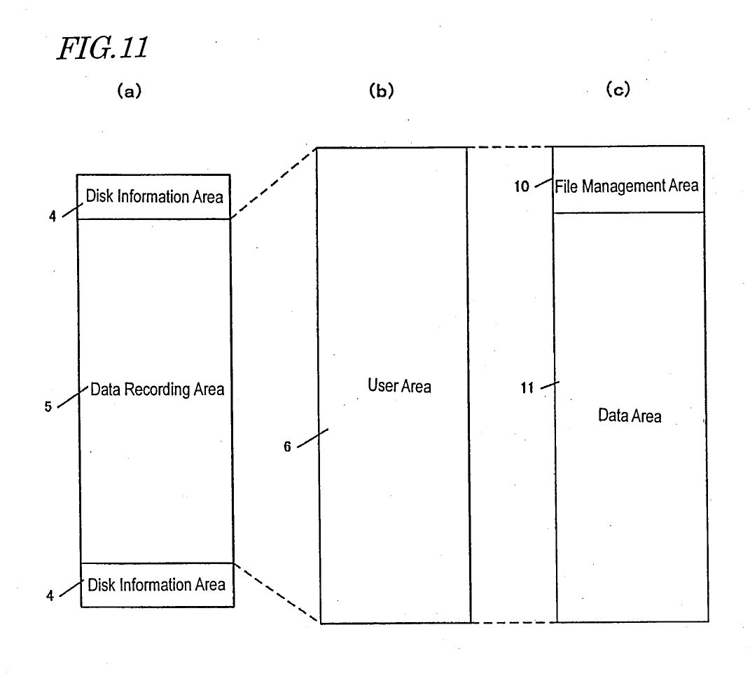

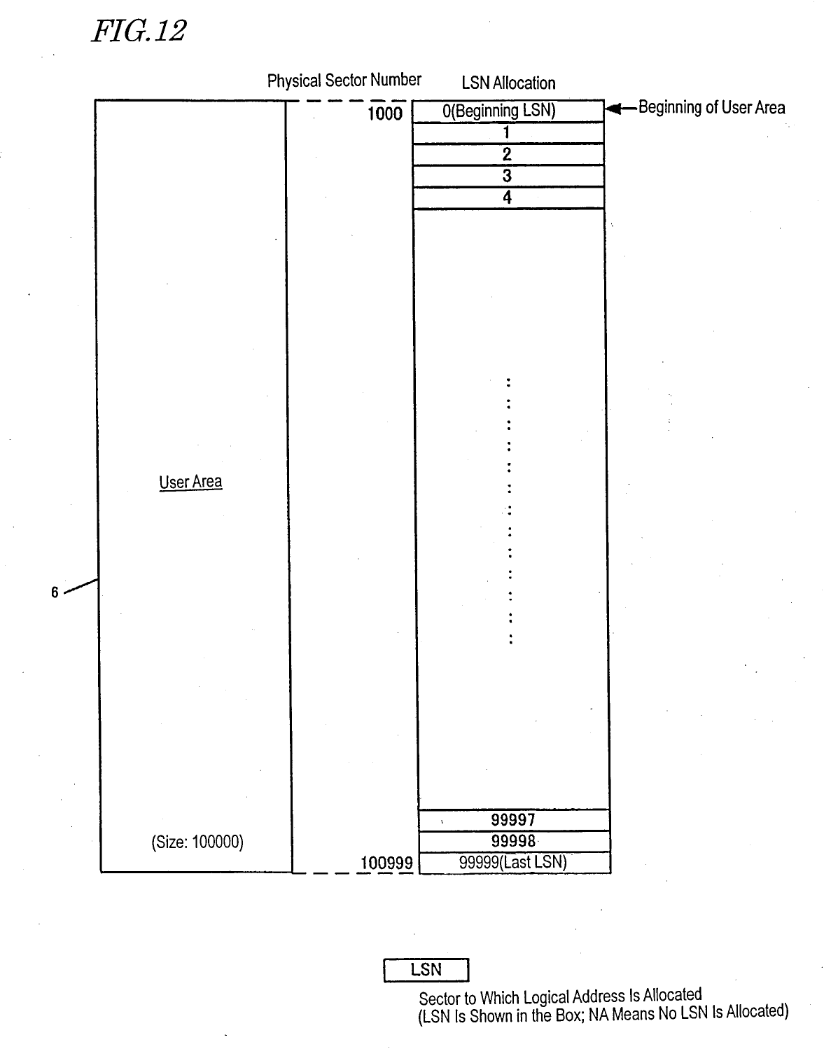

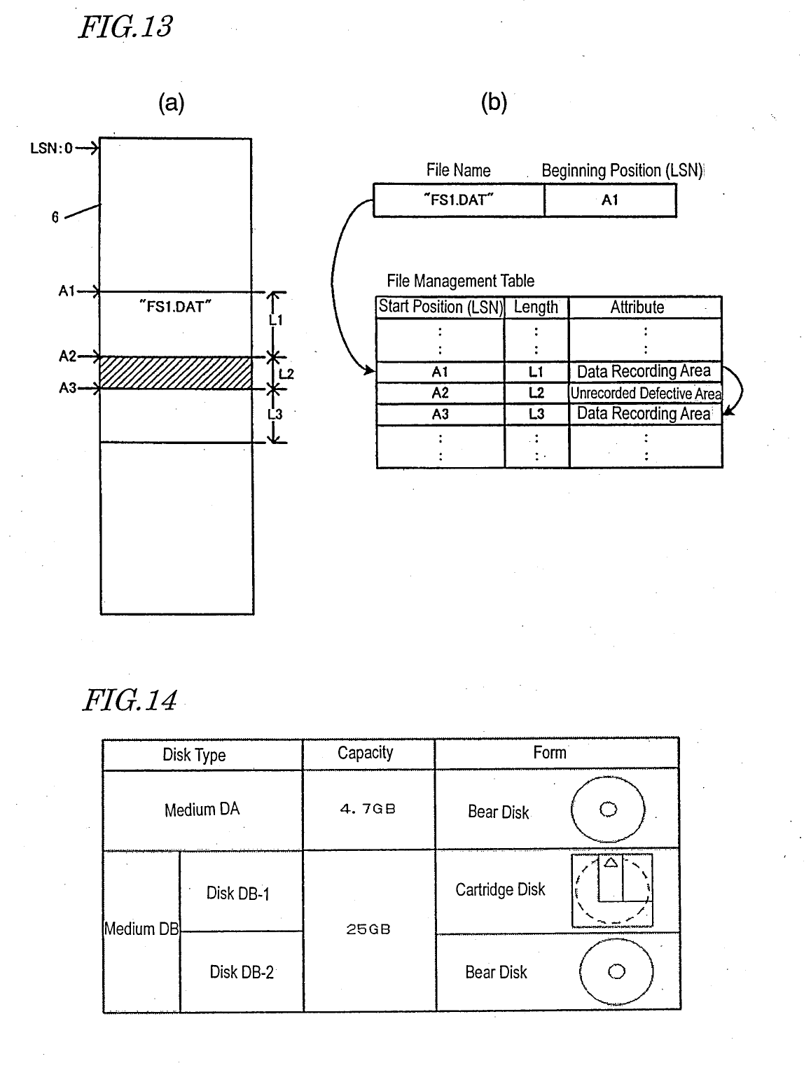

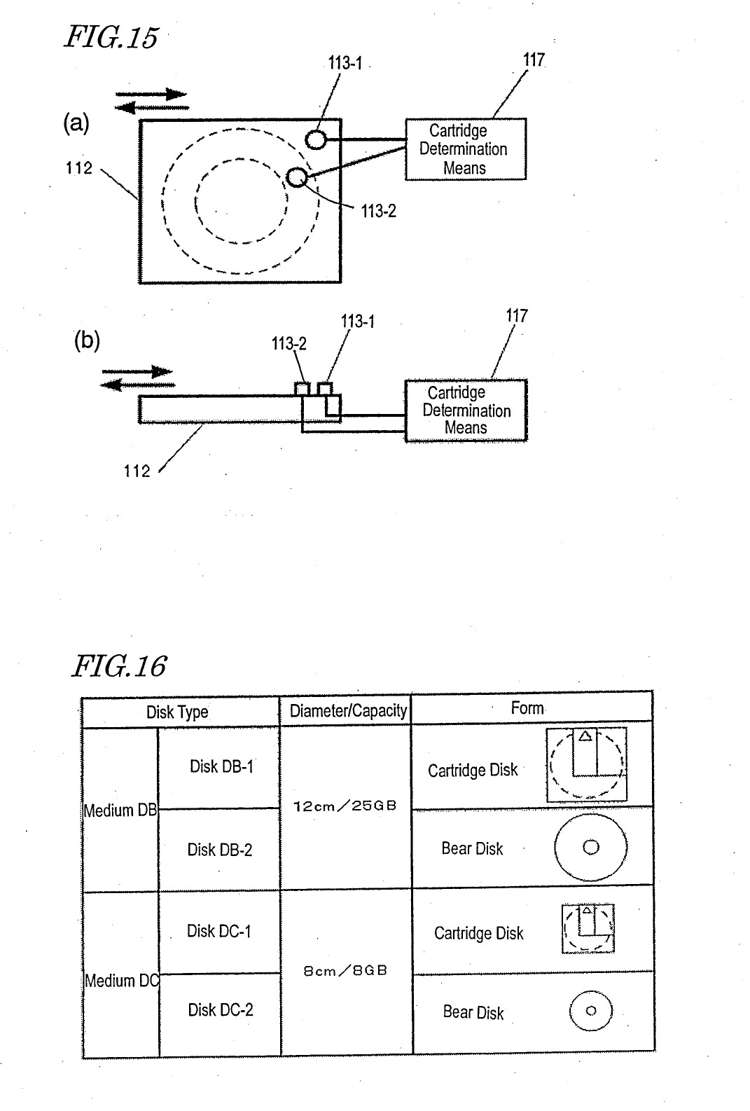

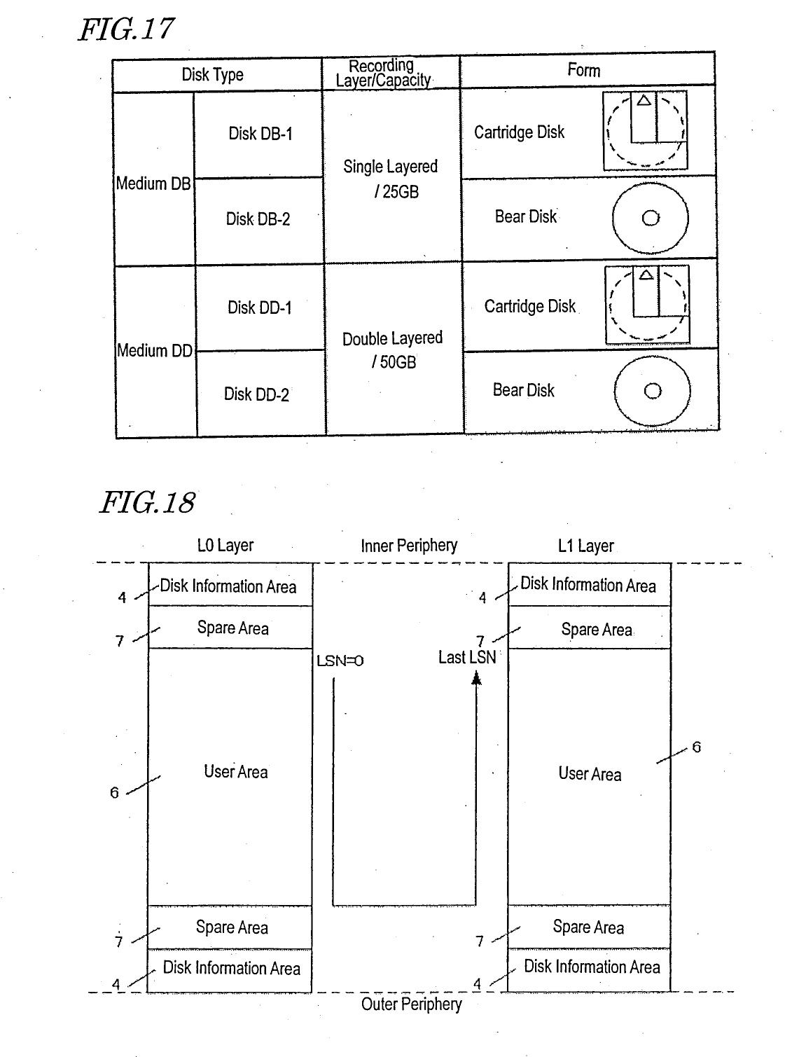

### BRIEF DESCRIPTION OF DRAWINGS

[FIG. 1] A diagram showing the structure of a commonly-used optical disk.

[FIG. 2] (a) to (c) are diagrams showing the logical structure of an optical disk 1.

[FIG. 3] A diagram showing a commonly-used data structure of a defect list 21.

[FIG. 4] A diagram showing the exterior appearance of a bear disk.

[FIG. 5] A diagram showing the exterior appearance of a cartridge disk.

[FIG. 6] A diagram showing the functional block construction of an information processing apparatus 100 according to the present embodiment.

[FIG. 7] (a) and (b) are diagrams showing the general construction of a cartridge determination means 106.

[FIG. 8] A diagram showing a disk information area 4 containing defect management information 20 and a defect list 21.

[FIG. 9] A diagram showing the data structure of defect management information 20.

[FIG. 10] A diagram showing an example allocation of a user area 6 and a spare area 7.

[FIG. 11] (a) is a diagram showing a state of the optical disk 1 in this case; (b) is a diagram showing a user area 6 which is allocated in the data recording area 5; and (c) is a diagram showing a state of the optical disk 1.

[FIG. 12] A diagram showing an example allocation of logical sectors in the user area 6.

[FIG. 13] (a) and (b) are diagrams showing an example of a replacement process using a file system.

[FIG. 14] A diagram showing types of optical disks to be determined according to Embodiment 2 of the present invention.

[FIG. 15] (a) and (b) are diagrams showing the locations of cartridge detection switches of an information processing apparatus 100 according to Embodiment 3 of the present invention.

[FIG. 16] A diagram showing types of optical disks to be determined according to Embodiment 3 of the present invention.

[FIG. 17] A diagram showing types of optical disks to be determined according to Embodiment 4 of the present invention.

[FIG. 18] A diagram showing an example of a double layered disk in which spare areas 7 are in split locations.

### DESCRIPTION OF THE REFERENCE NUMERALS

1 optical disk
2 track
3 sector
4 disk information area
5 data recording area
6 user area
7 spare area
10 file management area
11 data area
20 defect management information
21 defect list
100 information processing means
101 data input/output means
102 memory
103 processor
104 operation control means
105 disk recording/reproduction means
106 cartridge determination means
107 processor bus
110 operation buttons
111 display panel
112 disk tray
113, 113-1, 113-2 cartridge detection switch

### BEST MODE FOR CARRYING OUT THE INVENTION

Hereinafter, embodiments of the present invention will described with reference to the attached drawings.

### Embodiment 1

In the present embodiment, a rewritable optical disk having a sector structure will be described. DVD-RAMs and Blu-ray discs are known as such optical disks, for example. Since the sector structure is in itself known, a commonly-used optical disk having a sector structure will be described as an “optical disk 1” also in the present embodiment, by referring to FIG. 1. Note that the optical disk is only an example of an optical storage medium, and is not limited to that which is disk-shaped. As another optical storage medium, a card which permits optical reading of data is also applicable.

FIG. 1 shows the structure of the optical disk 1. On the optical disk 1, tracks 2 are formed in concentric circles. Finely-divided sectors 3 are formed in each track. In each sector 3, an absolute address, called a physical sector number PSN (Physical Sector Number), is assigned.

The optical disk 1 is composed of disk information areas 4 and a data recording area 5. The disk information areas 4, which are located at the innermost periphery side and the outermost periphery side of the optical disk 1, store parameters and the like which are necessary for accessing the optical disk 1. The disk information areas 4 are also called lead-in, lead-out, etc. In one of the data recording areas 5, data (user data) such as video data and audio data is stored.

In the present specification, two types of optical disks will be described whose appearances differ based on the presence or absence of a closed-type cartridge. An optical disk which lacks a cartridge will be referred to as a “bear disk”. An optical disk which is accommodated within a cartridge will be, as a whole, referred to as a “cartridge disk”. Although these optical disks have the same optical characteristics regarding the optical disk alone, it can also be said that their physical characteristics differ in terms of whether they are accommodated in a cartridge or not. Hereinafter, any cartridge disk, including its cartridge, will be regarded as one storage medium.

FIG. 4 shows the exterior appearance of a bear disk. As described above, a bear disk is an optical disk itself which is not accommodated within a cartridge. A bear disk is to be mounted as it is on a tray of an information processing apparatus described below.

FIG. 5 shows the exterior appearance of a cartridge disk. In FIG. 5, an optical disk 1 which is accommodated within a cartridge is indicated by a dotted line. The optical disk 1 is identical to the bear disk shown in FIG. 4. The cartridge disk is to be mounted, together with its cartridge, on a tray of an information processing apparatus described below.

FIG. 6 shows the functional block construction of an information processing apparatus 100 according to the present embodiment. Hereinafter, fundamental and characteristic operations of the information processing apparatus 100 will be described, and thereafter the functions of the respective constituent elements will be described. Although FIG. 6 illustrates the optical disk 1 to be present within the tray 112, the optical disk 1 is detachable from the information processing apparatus 100, and therefore is not a constituent element of the information processing apparatus 100.

The information processing apparatus 100 is able to write data to the optical disk 1 and read and output the data which has been written to the optical disk 1. For example, this data is video, audio, PC, or other data.

Furthermore, one feature of the information processing apparatus 100 of the present embodiment is that it determines whether the mounted optical disk 1 is a bear disk or a cartridge disk, and executes a physical formatting process by a defect management method which differs depending on the determined type. More specifically, when it is determined that a bear disk has been mounted, as shown in FIGS. 2(a) and (b), the information processing apparatus 100 forms a user area 6 and a spare area 7 in the data recording area 5. On the other hand, when it is determined that a cartridge disk has been mounted, the information processing apparatus 100 does not form a spare area 7 in the data recording area 5, but only forms a user area 6.

The rationale for being able to adopt a different defect management method depending on the type of the optical disk 1 is as follows. Firstly, a bear disk has a high likelihood of allowing defective sectors to emerge due to dirt or soil attached to its surface. Therefore, as a countermeasure to errors during recording, it is necessary to provide the spare area 7 for substituting the defective sectors. On the other hand, in a cartridge disk, the surface of the optical disk 1 is never exposed, and therefore dirt or soil is not likely to adhere. The likelihood that defective sectors may appear is low, and it is considered that hardly any errors would occur during recording. This is an effect which is obtained based on enclosure within the cartridge. Since the cartridge ensures reliability of the optical disk 1, no problem arises from not providing a spare area 7 in the data recording area 5. As a result, there is provided an optical disk 1 which allows a greater amount of data to be recorded than a bear disk, while ensuring reliability based on enclosure within the cartridge.

Although there is a possibility for a cartridge disk to have defective sectors, it is considered that no major problem will arise even if substitution is not performed by using a spare area 7. The reason is that, in a recording of video images, which is expectable as a purpose of large-capacity optical disks, even if recording fails in one sector in the middle, such failure will be hardly noticeable to the human eyes, and there will be no influence on the reproduced video. It must however be noted that, when writing video data to the data area 11 as shown in FIG. 2(c), another writing method (e.g. a drop recording method) may be employed, which does not perform substitution even when write errors occur. However again, even if redirection to the spare area were to be performed only when defective sectors occur in the file management area 10, there would be no problem if a method such as file-system-based duplication is applied to ensure reliability of the file management area 10.

The information processing apparatus 100 according to the present embodiment provides a spare area 7 for a bear disk, and does not provide any spare area 7 for a cartridge disk. Such distinction promotes the user's convenience because the user can then determine whether the recording capacity is large or small based on the presence or absence of a cartridge. On the other hand, it would presumably become possible for the manufacturer of the information processing apparatus 100 to reduce production costs because the operation of the information processing apparatus 100 can be simply defined in such a manner that a spare area 7 is not provided or provided based on the presence or absence of a cartridge. Although it would be possible to perform a physical formatting process so as not to provide any spare area 7 when a bear disk is mounted, other complicated data writing methods would have to be adopted for ensuring reliability in that case. However, the present invention does not preclude cases where no spare area 7 is provided in a bear disk.

Hereinafter, details of the information processing apparatus 100 will be described.

The information processing apparatus 100 includes a data input/output means 101, a memory 102, a processor 103, an operation control means 104, a disk recording/reproduction means 105, a cartridge determination means 106, a processor bus 107, operation buttons 110, a display panel 111, and a tray 112.

The data input/output control means 101 controls inputting of external data and external outputting of data, and handles storage to and retrieval from a data buffer on the memory 102. Such data is used for performing a write or read.

The memory 102 stores data which is exchanged during processing by the information processing apparatus 100. For example, the memory 102 stores program data and/or data which is received from or will be sent out through the data input/output means 101. The memory 102 also stores video or image data to be displayed on the display panel 111.

The processor 103 is a so-called computer. The processor 103 executes a program which is stored in the memory 102, and controls a device which is connected to the processor bus 107.

The operation control means 104 monitors requests to the information processing apparatus 100, and passes a request from the operation buttons 110 to the processor 103. In accordance with an instruction from the processor 103, the operation control means 104 causes the display panel 111 to display video or images.

The disk recording/reproduction means 105 writes data which is stored in the memory 102 to a designated address on the optical disk 1 that is inserted onto the tray 112. Moreover, the disk recording/reproduction means 105 reads data from a designated address of the optical disk 1, and stores it to the memory 102.

Based on a signal which is connected to the tray 112, the cartridge determination means 106 determines whether the optical disk 1 on the tray 112 is contained in a cartridge or not, and notifies it to the processor 103.

The processor bus 107 is a high speed bus through which the processor 103 accesses the memory 102 or the control means 101 and 104.

Note that the data input/output control means 101, the operation control means 104, the disk recording/reproduction means 105, and the cartridge determination means 106 can be implemented by using hardware, e.g., a control chip, or implemented by using software, based on the processor 103 executing a computer program for realizing the respective functions.

The optical disk 1 is mounted to the information processing apparatus 100 by way of the tray 112. The operation buttons 110 and the display panel 111 are connected to the operation control means 104. The operation buttons 110 are an input interface with which the user exploits the information processing apparatus 100, and may be buttons which are provided on the apparatus, or anything that enables inputting, e.g., a keyboard, an infrared remote control, or a touch panel. The display panel 111 only needs to be able to perform outputting in accordance with the resolution of the images or video to be displayed, e.g., a television screen or an FL tube, so long as the information processing apparatus 100 is able to display text, images, or video to the user. Note that, in the case where the operation buttons 110 and the display panel 111 are provided within the housing of the information processing apparatus 100, these are constituent elements of the information processing apparatus 100. However, when these are implemented as buttons on a remote control and a display section of the remote control, etc., they may not be considered as constituent elements of the information processing apparatus 100 in the strict sense.

As described above, the information processing apparatus 100 is mainly composed of commonly-used constituent elements of a computer, and any device that includes such constituent elements can realize the information processing apparatus 100 according to the present embodiment. In the case where the information processing apparatus 100 is implemented as a home appliance, it may be a recorder device which records or reproduces video, for example. The recorder device would record a video signal from a broadcast-receiving tuner or an aux terminal to the optical disk 1 via the data input/output means 101. Moreover, the recorder device would output a video signal which has been reproduced from the optical disk 1 to an external display device such as a television set. The memory 102 would include an area in which a program for performing operations as a recorder device is stored, a buffer to be used for the compression/decompression of video data, and an area in which variables, which are necessary for program operations, are stored. As the processor 103 executes a program which is stored in the memory 203, the functions of the recorder device would be realized.

FIGS. 7(a) and (b) show the general construction of the cartridge determination means 106. FIG. 7(a) is an upper plan view, and FIG. 7(b) is a cross-sectional view. The tray 112 moves in the directions of the illustrated arrows.

The cartridge determination means 106 is connected to the cartridge detection switch 113, and determines the presence or absence of a cartridge based on a signal from the cartridge detection switch 113. In other words, the cartridge determination means 106 determines whether the mounted optical disk 1 is a bear disk or a cartridge disk.

The cartridge detection switch 113 is located above a tray 112 on which the optical disk 1 is placed, and is positioned so that it is pressed only when a cartridge disk is inserted and not pressed when a bear disk is inserted. The cartridge detection switch 113 outputs different signals depending on whether it has been pressed (contacted) or not. For example, it outputs a predetermined signal when pressed, and stops outputting a signal (i.e., outputs a signal whose amplitude is zero) when not pressed.

Based on a signal which is output from the cartridge detection switch 113, the cartridge determination means 106 can determine whether the optical disk 1 is a bear disk or a cartridge disk. Instead of a physical switch, any device that outputs a signal based on optical detection, e.g., a photosensor, may be used. A photosensor would be located so as to pair up with a light source which radiates light, and arranged so as to detect light when no cartridge exists, and not detect any light when a cartridge exists. Any other method may be adopted so long as the mechanism is able to distinguish a bear disk from a cartridge disk.

Hereinafter, operations of the information processing apparatus 100 will be described. The operations described below are to be performed after the type of the mounted optical disk 1 has been determined by the cartridge determination means 106. In the present embodiment, the type of the mounted optical disk 1 is either a bear disk or a cartridge disk. Therefore, the following descriptions will be divided between operations of the information processing apparatus 100 in the case where the mounted optical disk 1 is a bear disk and operations of the information processing apparatus 100 in the case where the mounted optical disk 1 is a cartridge disk. As used herein, the “operations” are: an initialization operation of the optical disk 1; a recording operation to the optical disk 1; and a reproduction operation from the optical disk 1.

(A) Operations of the Information Processing Apparatus 100 when the Mounted Optical Disk 1 is a Bear Disk

When a bear disk as shown in FIG. 4 is placed on the tray 112 and loaded into the information processing apparatus 100, the cartridge detection switch 113 is not pressed, so that the cartridge determination means 106 determines that the mounted optical disk 1 is a bear disk. Then, the following operations are performed.

(A1) Initialization Operation of a Bear Disk

(A1-1) The operation control means 104 receives an instruction for disk initialization which the user has input via the operation buttons 110, and passes it to the processor 103.

(A1-2) In accordance with the program which is stored in the memory 102, the processor 103 begins execution of a physical formatting process.

(A1-3) From the cartridge determination means 106, the processor 103 obtains the information that the optical disk 1 on the tray 112 is a bear disk. In this optical disk 1, only the areas as shown in FIG. 2(a) are defined (the areas in FIG. 2(b) are not allocated).

(A1-4) The processor 103 gives an instruction to the disk recording/reproduction means 105, and allocates a user area 6 and a spare area 7 in the data recording area 5 of the optical disk 1.

(A1-5) The disk recording/reproduction means 105 writes defect management information 20 and a defect list 21 to the disk information area 4. FIG. 8 shows the disk information area 4 containing the defect management information 20 and the defect list 21. FIG. 9 shows the data structure of the defect management information 20. To the defect management information 20 concerning the allocated user area 6 and spare area 7, position information (logical address, size information) and the like of each area are recorded. On the other hand, the defect list 21 is as shown in FIG. 3, and is similar to a conventional defect list. To the header portion in FIG. 3, number of entries=0 is written. At this time, the optical disk 1 is in a state shown in FIG. 2(b).

(A1-6) In accordance with the program stored in the memory 102, the processor 103 begins execution of a logical formatting process.

(A1-7) The processor 103 gives an instruction to the disk recording/reproduction means 105, and allocates a file management area 10 and a data area 11 in the user area 6 of the optical disk 1.

(A1-8) The disk recording/reproduction means 105 records an initial value (which is predefined for each file system) at a logical address that has been allocated to the file management area 10 in accordance with the instruction. The state of the optical disk 1 at this time is shown in FIG. 2(c).

(A1-9) The processor 103 controls the operation control means 104 to cause the display panel 111 to display “Initialization has been completed”.

(A2) Recording Operation to a Bear Disk

(A2-1) A disk recording instruction from the operation buttons 110 is received by the operation control means 104, which passes it to the processor 103.

(A2-2) In accordance with the program stored in the memory 102, the processor 103 begins execution of a recording process.

(A2-3) Via the disk recording/reproduction means 105, the processor 103 reads the logical address information of a vacant area stored in the file management area 10.

(A2-4) From the logical address of the vacant area, the processor 103 determines the value of an address at which to record a file.

(A2-5) Based on the determined address value, i.e., logical sector number LSN, the disk recording/reproduction means 105 records the file data to the data area 11.

(A2-6) When a defective sector is found during recording, the disk recording/reproduction means 105 records the data which would have been recorded to the defective sector to the spare area 7. At this time, two addresses, i.e., the address of the defective sector and the address of the substituted spare area, are registered to the defect list 21.

(A2-7) The processor 103 controls the operation control means 104 to cause the display panel 111 to display “RECORDING”.

(A3) Reproduction Operation from a Bear Disk

(A3-1) An instruction for disk reproduction from the operation buttons 110 is received by the operation control means 104, which passes it to the processor 103.

(A3-2) In accordance with the program stored in the memory 102, the processor 103 begins execution of a reproduction process.

(A3-3) The processor 103 determines, from the file location information stored in the file management area 10 and via the disk recording/reproduction means 105, an address from which to read.

(A3-4) Based on the determined read position information, i.e., logical sector number LSN, the disk recording/reproduction means 105 reads the file data from the data area 11.

(A3-5) The disk recording/reproduction means 105 refers to the defect list 21, and as for any position that was a defective sector during recording, reads data from the address of a registered substitute sector.

(A3-6) The processor 103 controls the operation control means 104 to cause the display panel 111 to display “PLAYBACK”.

FIG. 10 shows an example allocation of the user area 6 and the spare area 7. The user area 6 and the spare area 7 are provided on the bear disk, and a defective sector management utilizing the spare area 7 is performed.

An example is shown where an allocation is made so that the spare area 7 has a size of 10000 sectors and the user area 6 has a size of 90000, in the case where the data recording area 5 spans physical sector numbers 1000 to 100999 (size: 100000). Herein, logical sector numbers LSN: 0 to 89999 are allocated for the purpose of actually recording a file system and files. No logical sector numbers LSN are allocated to the spare area, which is to be used as substitute sectors when defective sectors occur.

Through the above-described procedure, initialization operation of a bear disk and recording/reproduction operations for a cartridge disk are realized. A bear disk has a high likelihood of experiencing write errors/read errors due to dirt or soil attached to the disk surface. However, by securing a spare area, it becomes possible to perform substitutions for the defective sectors during recording, thus ensuring reliability. Moreover, since redirection to the spare area is performed by the disk recording/reproduction means 105, the user area 6 may be managed by any file system. For example, a general file system such as FAT or UDF may itself be utilized for the management of the user area 6.

(B) Operations of the Information Processing Apparatus 100 when the Mounted Optical Disk 1 is a Cartridge Disk

When a cartridge disk as shown in FIG. 5 is placed on the tray 112 and loaded into the information processing apparatus 100, the cartridge detection switch 113 is pressed, so that the cartridge determination means 106 determines that the mounted optical disk 1 is a cartridge disk. Then, the following operations are performed.

(B1) Initialization Operation of a Cartridge Disk

(B1-1) The operation control means 104 receives an instruction for disk initialization from the operation buttons 110, and passes it to the processor 103.

(B1-2) In accordance with the program which is stored in the memory 102, the processor 103 begins execution of a physical formatting process.

(B1-3) From the cartridge determination means 106, the processor 103 obtains the information that the optical disk 1 on the tray 112 is a cartridge disk (i.e., a disk which is inserted and enclosed in a cartridge). FIG. 11(a) shows the state of the optical disk 1 at this time.

(B1-4) The processor 103 gives an instruction to the disk recording/reproduction means 105, and allocates a user area 6 in the data recording area 5 of the optical disk 1. FIG. 11(b) shows the user area 6 allocated in the data recording area 5. The state of the optical disk 1 at this time is shown in FIG. 11(b). It will be understood that a spare area 7 (FIG. 2(b)) is not included in FIG. 11(b).

(B1-5) The disk recording/reproduction means 105 writes defect management information 20 and a defect list 21 to the disk information area 4 shown in FIG. 8. FIG. 9 shows the data structure of the defect management information 20. To the defect management information 20, addresses of the allocated user area 6 and the like are recorded. Zero is recorded as the position information and size information of the spare area. FIG. 3 shows the data structure of the defect list 21. To the header portion in FIG. 3, number of entries=0 is written.

(B1-6) In accordance with the program stored in the memory 102, the processor 103 begins execution of a logical formatting process.

(B1-7) The processor 103 gives an instruction to the disk recording/reproduction means 105, and allocates a file management area 10 and a data area 11 in the user area 6 of the optical disk 1.

(B1-8) The disk recording/reproduction means 105 writes an initial value (which is predefined for each file system) at an address that has been allocated to the file management area 10 in accordance with the instruction. FIG. 11(c) shows the state of the optical disk 1.

(B1-9) The processor 103 controls the operation control means 104 to cause the display panel 111 to display “Initialization has been completed”.

(B2) Recording Operation to a Cartridge Disk

(B2-1) A disk recording instruction from the operation buttons 110 is received by the operation control means 104, which passes it to the processor 103.

(B2-2) In accordance with the program stored in the memory 102, the processor 103 begins execution of a recording process.

(B2-3) Via the disk recording/reproduction means 105, the processor 103 reads the address information of a vacant area stored in the file management area 10.

(B2-4) From the address information of the vacant area, the processor 103 determines an address at which to record a file.

(B2-5) Based on the determined address information, i.e., logical sector number LSN, the disk recording/reproduction means 105 records the file data to the data area 11.

(B2-6) The processor 103 controls the operation control means 104 to cause the display panel 111 to display “RECORDING”.

(B3) Reproduction Operation from a Cartridge Disk

(B3-1) An instruction for disk reproduction from the operation buttons 110 is received by the operation control means 104, which passes it to the processor 103.

(B3-2) In accordance with the program stored in the memory 102, the processor 103 begins execution of a reproduction process.

(B3-3) The processor 103 determines, from the file location information stored in the file management area 10 and via the disk recording/reproduction means 105, an address from which to read.

(B3-4) Based on the determined read position information, i.e., logical sector number LSN, the disk recording/reproduction means 105 reads the file data from the data area 11.

(B3-5) The processor 103 controls the operation control means 104 to cause the display panel 111 to display “PLAYBACK”.

FIG. 12 shows an example allocation of logical sectors in the user area 6.

In a case where the data recording area 5 spans physical sector numbers 1000 to 100999 (size: 100000), a size of 100000 is allocated to the user area 6. Herein, logical sector numbers LSN: 0 to 99999 are allocated to all sectors in the user area 6, thus allowing a file system to be constructed and files to be recorded.

Through the above-described procedure, initialization of a cartridge disk and recording/reproduction operations for a cartridge disk are realized. A cartridge disk ensures reliability by being encased in a cartridge for preventing dirt or soil from adhering to the disk surface, and further allows the entire user area 6 to be used.

The above-described processes may admit various variants. Hereinafter, first and second variants will be described.

Firstly, a first variant relates to recording step (B2-5) when a cartridge disk is mounted.

Even a cartridge disk may experience recording errors due to aging. In this case, reliability can be ensured through a replacement process based on a file system.

FIGS. 13(a) and (b) show an example of a replacement process using a file system. FIG. 13(a) shows a data area 11 in the case where a defective area exists in an area to which a file FS1.DAT is written. In FIG. 13(a), A1, A2 and A3 represent beginning logical sector numbers LSN of respective areas, whereas L1, L2 and L3 represent the lengths of the respective areas. An area which has been skipped as a defective area has the beginning logical sector number LSN A2 and the length L2.

The FS1.DAT file is kept under management based on a file management table which is stored in the file management area 10. FIG. 13(b) schematically shows an example of a file management table. In the management table, which is linked from a file entry of the FS1.DAT file stored in root directory information, information of the beginning logical sector number LSN and length of an area in which the FS1.DAT file is located is stored. Furthermore, this management table also stores information indicating an attribute as to whether the area is a data-recorded area or an unrecorded defective area. When a recording error occurs at recording step (2-5) described above, data which would have been written in the errored position is recorded to a subsequent sector.

At this time, in the management table, information concerning the position where a write was not performed is recorded together with the information concerning attribute of the unrecorded defective area. By utilizing these pieces of information, it is possible at the time of reproduction to determine that this area is a defective area. Thus, it becomes possible to perform a read in accordance with an address having the attribute of the data recording area. In the example of FIGS. 13(a) and (b), information concerning three areas is stored with respect to FS1.DAT, thus indicating that data is recorded in an area having a length L1 from a start position A1 and an area having a length L3 from a start position A3, and that an area having a length L2 from a start position A2 is skipped as a defective area with no data being recorded therein.

By thus performing a replacement process for defective sectors based on the file system, it becomes possible to ensure even higher reliability.

Next, a second variant will be described. A variant of initialization step (B1-5) and (B2-5) in the case where a cartridge disk is mounted is described now.

Even a cartridge disk may experience recording errors due to aging. As described above, if a recording error occurs at recording step (B2-5), the address where the recording error has occurred is not subjected to a replacement process, but is registered to the defect list 21. As the address of the defective sector, the address at which the error has occurred is registered, and a value which is not expected as a usual address value (e.g. 0”) is registered as the address of a substitute sector. Alternatively, information indicating lack of a substitute sector may be added and registered.

When initializing the defect list at initialization step (B1-5), if there exists any defective sector that is already registered, the address(es) thereof is registered to the file management area 10. Thus, when recording a file, it is possible to perform the allocation while avoiding this area(s).

Similarly, when performing a replacement process based on the file system, the address of any defective position at which a recording error has occurred may be registered to the defect list 21, and reflected on the file management area 10 at the time of disk initialization, whereby it becomes possible for the file system to carry out file location so as to avoid the defective address(es).

Thus, by registering the address information of defective sectors which are not subjected to a replacement process, it becomes possible for the file system to carry out file location so as to avoid the defective sectors, whereby an even higher reliability can be ensured.

### Embodiment 2

In the present embodiment, an information processing apparatus which is capable of determining still another type of optical disk having different physical characteristics will be described. While Embodiment 1 performs type determination regarding one type of optical disk based on its appearance, in the present embodiment, the type of an optical disk is determined also based on differences in the physical characteristics (recordable capacity) of the recording layer.

The information processing apparatus according to the present embodiment has the same constituent elements as those of the information processing apparatus 100 shown in FIG. 6, and therefore will be described as the “information processing apparatus 100” below, and the descriptions thereof will be omitted.

FIG. 14 shows types of optical disks which can be determined according to the present embodiment. The information processing apparatus 100 according to the present embodiment first determines which one of a medium DA and a medium DB has been mounted. For example, the medium DA may be a DVD-RAM disk having a maximum recordable capacity of 4.7 gigabytes (GB), whereas the medium DB may be a Blu-ray disc having a maximum recordable capacity of 25 GB.

Both the media DA and DB are similar in disk structure to the optical disk 1 of FIG. 1, which has been described in Embodiment 1. The medium DA and the medium DB differ with respect to the physical characteristics of their recording layers. Specifically, they differ from each other with respect to the track width and the recording film, and therefore, they differ with respect to: the number of recording bits (track recording density) per unit length along the circumferential direction of the disk; the number of tracks (track density) per unit length along the radial direction; and the areal density, which is expressed as a product of the track recording density and the track density. Since they differ with respect to the physical characteristics of their recording layers, they also differ in their optical characteristics. Note that information concerning the disk type, which identifies itself to be the medium DA or DB, is recorded in the disk information area 4 shown in FIG. 2.

Furthermore, the medium DB can be mounted in two forms: a bear disk or a cartridge disk. Hereinafter, a medium DB in cartridge form will be referred to as a disk DB-1, whereas a medium DB in bear disk form will be referred to as disk DB-2. Note that, the present embodiment assumes that any DVD-RAM disk is a bear disk. However this is only for the sake of simplicity of description, and a DVD-RAM disk is also capable of being accommodated within a cartridge.

When it is determined that a Blu-ray disc has been mounted, the information processing apparatus 100 further determines whether it is accommodated in a cartridge or not, i.e., whether it is a cartridge disk or a bear disk. This determination method is as described in Embodiment 1.

With respect to the information processing apparatus having the above construction, an operation of the information processing apparatus 100 when a disk DB-1 is mounted and the disk DB-1 is to be initialized, for example, will be specifically described.

First, the disk recording/reproduction means 105 radiates laser light while rotating the disk 1 on the tray 112, and determines whether the type of the mounted optical disk 1 is medium DA or DB. For example, the reflectance of the medium DA is different from the reflectance of the medium DB; therefore, the disk recording/reproduction means 105 receives reflected light from the recording layer of the optical disk 1, and thus the type of the medium can be determined based on differences in the received light amount. Alternatively, information indicating the disk type may be read from the disk information area 4 and subjected to determination. Alternatively, the recording capacity of the medium DA is different from the recording capacity of the medium DB; therefore, determination can also be made by reading the size or last physical address of the data recording area 5. Thus, the information processing apparatus 100 determines that the medium DB has been inserted.

The subsequent operation of the information processing apparatus 100 is similar to initialization steps (B1-1) to (B1-9) described in Embodiment 1. After further determining that it is a cartridge disk, an initialization of the optical disk may be performed.

Next, an operation of the information processing apparatus 100 when a disk DB-1 is mounted and data is to be written to the disk DB-1 will be described. The information processing apparatus 100 sequentially executes a determination process for the disk DB-1 and a data writing process for the disk DB-1. The former, determination process is identical to the above-described process of determining a medium in an initialization process. On the other hand, the latter, writing process is similar to recording steps (B2-1) to (B2-6) described in Embodiment 1, except that medium determination is executed before step (B2-3).

Next, an operation of the information processing apparatus 100 when a disk DB-1 is mounted and data is to be read from the disk DB-1 will be described. The information processing apparatus 100 sequentially executes a determination process for the disk DB-1 and a data reading process from the disk DB-1. The former, determination process is identical to the above-described process of determining a medium in an initialization process. On the other hand, the latter, reading process is similar to reproduction steps (B3-1) to (B3-5) described in Embodiment 1, except that the medium determination described in the aforementioned initialization operation is executed before reproduction step (B3-3).

Through the above processes, initialization, recording, and reproduction operations for the disk DB-1 become possible. Effects similar to those in Embodiment 1 can be obtained for media of multiple types (especially types based on physical characteristics and optical characteristics), too.

The above description assumes that the optical disk 1 to be subjected to processing is a disk DB-1 (i.e., a Blu-ray disc which is accommodated in a cartridge). In the case where the optical disk 1 is a disk DB-2 (i.e., a bear Blu-ray disc which is not accommodated in a cartridge), or a medium DA (i.e., bear DVD-RAM disk), the above-description should read on the steps of initialization, recording, and reproduction for a bear disk in Embodiment 1.

Although the present embodiment assumes that the medium DA is a DVD-RAM disk, it may be a CD-RW whose maximum recordable capacity is 650 megabytes, for example.

### Embodiment 3

In the present embodiment, an information processing apparatus which is capable of determining still other types of optical disks having different physical characteristics (appearances of optical disks) will be described.

The information processing apparatus in the present embodiment has substantially the same constituent elements as those of the information processing apparatus 100 shown in FIG. 6, and therefore will be described as the “information processing apparatus 100” below, and the descriptions thereof will be omitted. However, the exact construction concerning cartridge detection switches differs from the cartridge detection switch 113 according to Embodiment 1 (FIGS. 7(a) and (b)), and therefore will be described below.

FIGS. 15(a) and (b) show locations of cartridge detection switches of the information processing apparatus 100 according to the present embodiment. FIG. 15(a) is an upper plan view, and FIG. 15(b) is a cross-sectional view. The tray 112 moves in the directions of illustrated arrows.

The tray 112 according to the present embodiment includes two cartridge detection switches 113-1 and 113-2 in different positions. Their positions are determined based on the shapes of the optical disks and cartridge disks to be mounted.

Hereinafter, with reference to FIG. 16, the respective shapes of the cartridge disks according to the present embodiment will be described. FIG. 16 shows types of optical disks which can be determined by the information processing apparatus 100 according to the present embodiment. There are generally two types of optical disks. One is a medium DB which has a diameter of 12 cm and a maximum recordable capacity of 25 GB (e.g., a standard diameter Blu-ray disc), and the other is a medium DC which has a diameter of 8 cm and a maximum recordable capacity of 8 GB (small diameter Blu-ray disc). The medium DB and the medium DC are identical with respect to the physical characteristics of their recording layers, and only differ in disk diameters.

Each of the media DB and DC is further divided into a cartridge disk and a bear disk, and all of these are mountable to the information processing apparatus 100. Hereinafter, a medium DB in cartridge form will be referred to as a disk DB-1, and a medium DB in bear disk form will be referred to as a disk DB-2. Moreover, a medium DC in cartridge form will be referred to as a disk DC-1, and a medium DC in bear disk form will be referred to as a disk DC-2. Therefore, in the present embodiment, optical disks of four types of physical characteristics are to be mounted to the information processing apparatus 100, and subjected to determination.

Now, referring back to FIGS. 15(a) and (b), the positions of the cartridge detection switches 113-1 and 113-2 which are provided on the tray 112 will be described. First, the cartridge detection switch 113-1 is pressed when the cartridge disk DB-1 having a diameter of 12 cm is mounted, and not pressed when the bear disk DB-2 having a diameter of 12 cm or the disk DC-1 or DC-2 having an even smaller diameter is mounted. Therefore, depending on whether the cartridge detection switch 113-1 has been pressed or not, it can be determined whether it is the cartridge disk DB-1 or not.

On the other hand, the cartridge detection switch 113-2 is not pressed when the bear disk DC-2 having a diameter of 8 cm is mounted, and pressed when the cartridge disk DC-1 having a diameter of 8 cm or the disk DB-1 or DB-2 having a greater diameter is mounted. Thus, based on a signal which is output depending on whether the cartridge detection switch 113-2 has been not pressed or pressed, it can be determined whether it is the bear disk DC-2 or not.

Note that, since the disk BD-2 and the disk DC-1 will press neither one of the cartridge detection switches 113-1 and 113-2, it cannot be determined which medium has been mounted based on output signals therefrom. However, based on the motor torque which is required for rotating the optical disk, determination as to the disk BD-2 or the disk DC-1 can be made. This is because the 12 cm disk DB-2 and the 8 cm disk DC-1 have different disk masses, thus resulting in different torques (that is, current amounts) for controlling the motor at the same revolutions.

In the information processing apparatus having the above construction, an operation of the information processing apparatus 100 when the disk DC-2 is mounted and the disk DC-2 is to be initialized, for example, will be specifically described.

First, when the optical disk 1 is mounted, the cartridge determination means 117 receives signals which are output from the cartridge detection switches 113-1 and 113-2, and determines whether the mounted optical disk is the disk DB-1, the disk DC-2, or any other disk (disk DB-2 or disk DC-1). Since the disk DC-2 is mounted now, signals whose amplitude is zero are output from the cartridge detection switches 113-1 and 113-2. Therefore, the cartridge determination means 117 determines that the disk DC-2 is mounted. The subsequent operation is similar to initialization steps (A1-1) to (A1-9) described in Embodiment 1. After further determining that it is a bear disk, an initialization of the optical disk may be performed.

The operation of the information processing apparatus 100 when the disk DC-2 is mounted and data is to be written to the disk DC-2 is similar to recording steps (A2-1) to (A2-7) in Embodiment 1, except that the medium determination is executed before step (A2-3).

Next, the operation of the information processing apparatus 100 when the disk DC-2 is mounted and data is to be read from the disk DC-2 is similar to reproduction steps (A3-1) to (A3-6) in Embodiment 1, except that the medium determination described in the aforementioned initialization operation is executed before step (3-3).

Through the above processes, initialization, recording, and reproduction operations for the disk DC-2 become possible. Effects similar to those in Embodiment 1 can be obtained for media of multiple types (especially types based on disk diameters and presence or absence of a cartridge), too.

In the present embodiment, output signals from the cartridge detection switches 113-1 and 113-2 are utilized for determining the type of the mounted optical disk. However, other methods can also be used. For example, while the disk recording/reproduction means 105 rotates the disk on the tray 112, laser light may be radiated at a position which is 8 to 12 cm from the center of the optical disk, and determination as to the disk DB or the disk DC can be made based on whether reflected light has been received or not. Alternatively, when information indicating the type of the disk is stored in the disk information area 4 shown in FIG. 2, this information may be read from the disk information area 4 and subjected to determination. Alternatively, since the recording capacity of the medium DB is different from the recording capacity of the medium DC, determination can also be made by reading the size or last physical address of the data recording area 5.

Note that, although the media DB and DC shown in FIG. 16 are illustrated as subjects of determination in the present embodiment, the medium DA shown in FIG. 14 may further be included as a subject of determination. In this case, for example, it is determined whether the mounted optical disk is the medium DA or not, and if it is the medium DA, then the processing according to Embodiment 2 is performed. If it is not the medium DA, it is determined that either the medium DB or the medium DC has been mounted, and the aforementioned processing according to the present embodiment may be performed.

### Embodiment 4

In the present embodiment, an information processing apparatus which is capable of determining still other types of optical disks having different physical characteristics (number of recording layers) will be described.

The information processing apparatus in the present embodiment has substantially the same constituent elements as those of the information processing apparatus 100 shown in FIG. 6, and therefore will be described as the “information processing apparatus 100” below, and the descriptions thereof will be omitted.

FIG. 17 shows types of optical disks which can be determined by the information processing apparatus 100 according to the present embodiment. There are generally two types of optical disks. One is a medium DB which has a single recording layer and a maximum recordable capacity of 25 GB (e.g., a single layered Blu-ray disc), and the other is a medium DD which has a plurality of recording layers and a maximum recordable capacity of 8 GB (e.g., a double layered Blu-ray disc). In the present embodiment, it is assumed that the medium DD is a medium which is a double-layered version of the medium DB, and has the same track width and recording film. Therefore, the track recording density and the track density are also the same.

However, assuming that the shallower recording layer is an L0 layer and the deeper recording layer is an L1 layer as seen from the face which is irradiated with laser light, the amount of reflected light from the L0 layer and the amount of reflected light from the L1 layer when laser light of the same intensity is radiated are different. Moreover, the position of the L0 layer of the medium DD and the position of the recording layer of the medium DB are at the same depth from the face that is irradiated with laser light. However, their reflected light amounts when laser light of the same intensity is radiated are different. The reason is that, when reflected light from the medium DD is detected, not only the reflected light from the L0 layer but also the reflected light from the deeper L1 layer is also detected. In other words, since the physical characteristics (number of layers) of the recording layers are different, the optical characteristics of the respective recording layers are also different. Note that these disk types are recorded in the disk information area 4 shown in FIG. 2.

Each of the media DB and DD is further divided into a cartridge disk and a bear disk, and all of these are mountable to the information processing apparatus 100. Hereinafter, as in Embodiment 2, a medium DB in cartridge form will be referred to as a disk DB-1, and a medium DB in bear disk form will be referred to as a disk DB-2. Moreover, a medium DD in cartridge form will be referred to as a disk DD-1, and a medium DD in bear disk form will be referred to as a disk DD-2. Therefore, in the present embodiment, optical disks of four types of physical characteristics are to be mounted to the information processing apparatus 100, and subjected to determination.

In the information processing apparatus having the above construction, an operation of the information processing apparatus 100 when the disk DD-2 is mounted and the disk DD-2 is to be initialized, for example, will be specifically described.

First, the disk recording/reproduction means 105 radiates laser light while rotating the disk 1 on the tray 112, and determines whether the type of the mounted optical disk 1 is medium DB or DD. For example, the reflected light amount of the medium DB is different from the reflected light amount from the medium DD; therefore, the disk recording/reproduction means 105 receives reflected light from the recording layer of the optical disk 1, and thus the type of the medium can be determined based on differences in the received light amount. Alternatively, information indicating the disk type may be read from the disk information area 4 and subjected to determination. Alternatively, the recording capacity of the medium DB is different from the recording capacity of the medium DD; therefore, determination can also be made by reading the size or last physical address of the data recording area 5. Thus, the information processing apparatus 100 determines that the medium DD has been inserted.

The subsequent operation of the information processing apparatus 100 is similar to initialization steps (A1-1) to (A1-9) described in Embodiment 1. After further determining that it is a bear disk, an initialization of the optical disk may be performed.

Now, the position(s) of the spare area(s) 7 to be provided on the disk DD-2 during initialization will be described. At least one spare area 7 may be provided on the disk DD-2. For example, a spare area 7 may be provided only at the inner periphery side of the L1 layer. This will make it possible to use all of the data recording area 5 of the L0 layer as the user area 6. Since the L0 layer (which is closer to the face that is irradiated with laser light) is more susceptible to scratches than the L1 layer, a spare area 7 may be provided only for the L0 layer, while not providing any spare area 7 for the L1 layer as in the case of a cartridge disk.

On the other hand, in the case where only one spare area 7 is provided on the disk DD-2, the data write and read may take time. In the above example, if a defective sector occurs at the outer periphery of the L1 layer, the optical head must be moved over to the spare area 7 at the inner periphery. Moreover, if a defective sector occurs in the L0 layer, the focal point of laser light must be moved to the L1 layer, and the optical head must further be moved to the spare area 7 at the inner periphery. This means that the adjustment of the focal point position and the adjustment of the optical head position will take time, so that a write or a read will take time.

Therefore, it is effective to place the spare area 7 in split locations on the disk DD-2. FIG. 18 shows an example of the disk DD-2 where spare areas 7 are in split locations. In this example, the spare areas 7 are located in both of the L0 layer and L1 layer of the disk DD-2, and there is one each at the disk inner periphery and outer periphery for each layer, thus totaling four. The spare areas 7 in such locations may be consecutively provided in the procedure from initialization steps (A1-3) to (A1-8). As a result, the probability of a data write or data read being disabled by scratches and soil on the disk can be reduced.

Next, the operation of the information processing apparatus 100 when the disk DD-2 is mounted and data is to be written to the disk DD-2 is similar to recording steps (A2-2) to (A2-6) in Embodiment 1, except that the medium determination is executed before step (A2-3).

Moreover, the operation of the information processing apparatus 100 when the disk DD-2 is mounted and data is to be read from the disk DD-2 is similar to reproduction steps (A3-1) to (A3-5) in Embodiment 1, except that the medium determination is executed before step (A3-3).

Through the above processes, initialization, recording, and reproduction operations for the disk DD-2 become possible. Effects similar to those in Embodiment 1 can be obtained for media of multiple types (especially types based on the number of recording layers), too.

In the present embodiment, between the two types of media DB and DD, the initialization, recording, and reproduction operations in the case where the disk DD-2 (which is a bear disk) is mounted have been illustrated. By combining the processing according to the present embodiment with one or both of the determination processes according to Embodiments 2 and 3, it becomes possible for the information processing apparatus 100 to realize initialization, recording, and reproduction operations for all of the medium DA, the medium DB, the medium DC, and the medium DD.

### INDUSTRIAL APPLICABILITY

In accordance with the information processing apparatus of the present invention, disks are provided for which optimum defect management methods are adopted in accordance with the physical characteristics of the disks. Since the disk capacity can be put to maximum use, it is effective in the field of video or audio recording, which requires a large-capacity storage area.

1. An information processing apparatus capable of mounting a storage medium having a data recording area, the data recording area including a user area to which logical addresses are allocated in accordance with recording units, the apparatus comprising:
a determination section for, based on physical characteristics of the mounted storage medium, determining which one of a first storage medium accommodated in a cartridge and a second storage medium not accommodated in a cartridge has been mounted;
a processor for, based on a result of determination, giving an instruction that, when the second storage medium has been mounted, the data recording area be formed as the user area and a spare area to be used as a substitute if a defect exists in a recording unit of the user area, and giving an instruction that, when the first storage medium has been mounted, all area of the data recording area be formed as the user area; and
a recording section for, based on the instruction, forming the user area and/or the spare area in the data recording area of the mount storage medium.

2. The information processing apparatus of claim 1, wherein the determination section determines mounting of one of the first storage medium and the second storage medium based on physical characteristics of the storage medium which differ based on presence or absence of a cartridge.

3. The information processing apparatus of claim 2, further comprising a detection section for outputting different signals based on a change in physical state that is based on a physical shape of the cartridge,
wherein the determination section determines which one of the first storage medium and the second storage medium has been mounted based on the signal which is output from the detection section.

4. The information processing apparatus of claim 1, wherein,
the first storage medium and the second storage medium have substantially the same recording capacity;
the information processing apparatus is capable of mounting a third storage medium having a recording capacity different from recording capacities of the first storage medium and the second storage medium; and
the determination section further determines mounting of the third storage medium based on physical characteristics of the storage medium which differ depending on recording capacity.

5. The information processing apparatus of claim 1, wherein
the first storage medium and the second storage medium have substantially the same recording capacity;
the information processing apparatus is capable of mounting a third storage medium having a recording capacity different from recording capacities of the first storage medium and the second storage medium; and
the determination section further determines mounting of the third storage medium based on information indicating a disk type which is recorded on the mounted storage medium.

6. The information processing apparatus of claim 4, wherein,
the first storage medium and the second storage medium have substantially the same number of recording layers, and the third storage medium has a different number of recording layers from the number of recording layers of the first storage medium and the second storage medium; and
the determination section further determines mounting of the third storage medium based on optical characteristics which differ depending on the number of recording layers.

7. The information processing apparatus of claim 4, wherein,
the third storage medium has a different physical shape from those of the first storage medium and the second storage medium; and
the determination section further determines mounting of the third storage medium based on the physical shape.

8. The information processing apparatus of claim 7, further comprising a first detection section and a second detection section for outputting different signals based on a change in physical state that is based on a physical shape of the cartridge;
the first detection section and the second detection section are located so as to output different signals when the first storage medium is mounted, based on the physical shape of the cartridge, and output the same signal when the third storage medium is mounted; and
the determination section determines mounting of the third storage medium based on the signals which are output from the first detection section and the second detection section.

9. The information processing apparatus of claim 7, further comprising a driving section for driving a mounted storage medium, wherein,
in accordance with a mass of the mounted storage medium, the driving section adjusts a physical parameter which is necessary for driving the storage medium under a predetermined condition; and
the determination section determines mounting of the third storage medium based on information concerning the physical parameter adjusted by the driving section.

10. The information processing apparatus of claim 1, wherein,
the first storage medium and the second storage medium each includes an information area storing information identifying the type of storage medium, the information area being different from the data recording area; and
the determination section determines which one of the first storage medium and the second storage medium has been mounted by reading the information from the information area of the mounted storage medium.

11. The information processing apparatus of claim 1, wherein the processor gives an instruction that a data area and duplicated file management areas be allocated in the user area when the first storage medium has been mounted.

12. An area formation method to be executed in an information processing apparatus capable of mounting a storage medium having a data recording area, the data recording area including a user area to which logical addresses are allocated in accordance with recording units, the method comprising the steps of:
determining which one of a first storage medium accommodated in a cartridge and a second storage medium not accommodated in a cartridge has been mounted based on physical characteristics of the mounted storage medium;
based on a result of determination, giving an instruction that, when the second storage medium has been mounted, the data recording area be formed as the user area and a spare area to be used as a substitute if a defect exists in a recording unit of the user area, and giving an instruction that, when the first storage medium has been mounted, all area of the data recording area be formed as the user area; and
based on the instruction, forming the user area and/or the spare area in the data recording area of the mount storage medium.
